(19) United States
(12) Patent Application Publication
(10) Pub. No.: US 2018/0016406 A1
(43) Pub. Date: Jan. 18, 2018

(54) PRODUCTION OF POROUS POLYURETHANE LAYERS

(71) Applicant: Evonik Degussa GmbH, Essen (DE)

(72) Inventors: Thomas Lüthge, Consrade (DE); Martin Glos, Borken (DE)

(21) Appl. No.: 15/547,626

(22) PCT Filed: Feb. 12, 2016
(86) PCT No.: PCT/EP2016/052967

§ 371 Date: Jul. 31, 2017

(30) Foreign Application Priority Data
Mar. 3, 2015 (EP) 15157322.7

(51) Int. Cl. C08J 9/00; C08G 18/48; C08G 18/44; D06N 3/14; C08G 18/76

(52) U.S. Cl. CPC C08J 9/0042; D06N 3/14; C08G 18/7671; C08G 18/44; C08G 18/7621; C08G 18/4829; C08J 2375/08

(57) ABSTRACT

The use of particular silicon-containing compounds in the production of porous polyurethane layers for improving the flow properties of the reaction mixture which is reacting to form the polyurethane layer and/or for optimizing the cells of the resulting polyurethane layer, preferably for homogenizing the cell structure over the entire resulting polyurethane layer, especially in the context of artificial leather or foam film production, is described. The silicon-containing compounds have the following formula:

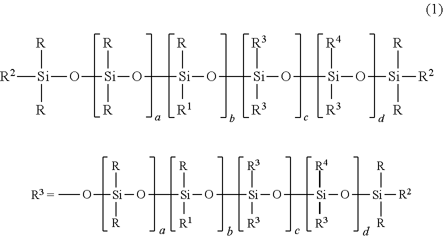

The present invention is in the field of polyurethanes. It relates to porous polyurethane layers and to the production thereof using particular silicon-containing compounds. It further relates to composite structures comprising such porous polyurethane layers. It further relates to the use of such composite structures as artificial leather or as foam film.

Porous polyurethane layers and the production thereof are known per se. The porous layers are often combined with nonporous layers. Porous polyurethane layers are usually a substantial constituent of multilayer composites which are, for example, applied to textile support materials in order to obtain, for example, imitation leathers, also known as artificial leather, as product.

Porous polyurethane layers can in principle be produced by three different processes, namely via coagulation, via PU dispersions or via high-solid processes.

The coagulation process is carried out using large amounts of solvent, predominantly dimethylformamide (DMF), which is of toxicological concern and is associated with corresponding difficulties with emissions from the corresponding end products.

The use of aqueous PU dispersions does have a significantly lower level of toxicologically problematical pollution. However, a very large quantity of energy is required in order to evaporate the amount of water.

Low-solvent or solvent-free processes having high solids contents, namely “high-solid” processes, are preferable both for toxicological reasons and in terms of energy consumption. Less energy is required in production and the finished products do not have any emission problems which could be caused by solvents. Such high-solid systems are known per se. For example, the patent applications EP 2476800 A1, WO 2014/012710 A1 and EP 1059379 A2 describe various high-solid systems which satisfy modern requirements.

The prior art describes siloxanes firstly as levelling agents in unfoamed, nonporous layers, in which they act as defoamers. Siloxanes have also been described merely as stabilizers for avoiding cell coalescence in foamed layers.

WO 2009/011776 A1 describes a process in which the reaction mixture is foamed mechanically. Here, a combination of various siloxanes, (AB)n types and comb types, are used in order to achieve better foam stability of the mechanically foamed reaction mixture, which then also results in foam layers having a lower density.

U.S. Pat. No. 4483894 likewise describes mechanically foamed systems which are stabilized by means of siloxanes having a molar mass of less than 30 000 g/mol, where the polyether side chains comprise at least 60% of oxyethylene units and the proportion of polydimethylsiloxane is 14-40% of the total mass of the siloxane.

WO 2008/012908 A1 describes mechanically foamed PU foams in which 50-80% of polytetramethylene polyols is used as polyol component and particular silicone surfactants are used. These have a proportion of polydimethylsiloxane of 5-20% by weight of the total mass and end-capped, i.e. not OH-functional, polyethers having molar masses of from 1000 to 2000 g/mol are present as side chains.

The production of high-quality porous foam layers is very difficult since different problems have to be solved simultaneously.

To be able to provide high-quality porous foam layers at all, efforts are made fundamentally to ensure good flow of the material which is to form the porous foam layer and also make satisfactory stabilization of the cells possible, so that uniformly structured and in particular fine-celled porous layers can be produced. Efforts are also fundamentally made to influence the cell size and the density of the foam layer according to requirements in order to be able to provide preferably tailored products.

Further requirements are to reduce the emissions of volatile organic compounds (VOC). Here, strict standards such as VDA 278 are employed especially in the automobile industry to qualify a material.

It was then a specific object of the present invention to improve the provision of porous polyurethane layers in such a way that both good flow of the reaction mixture and satisfactory stabilization of the cells can be ensured during production of the layers concerned so as to allow provision of uniformly structured and fine-cell porous layers.

It has surprisingly been found in the context of the present invention that the use of silicon-containing compounds of the formula (1) in the production of polyurethane layers makes it possible to achieve the abovementioned object.

The use of silicon-containing compounds in the production of polyurethanes is known per se. However, in the prior art, siloxanes are either used as defoamers in unfoamed, nonporous layers or siloxanes are described merely as stabilizers to avoid cell coalescence in foamed layers.

On the other hand, the siloxanes of the formula (1) to be used according to the invention, hereinafter also referred to as siloxanes, can surprisingly perform two functions in foamed layers, namely firstly stabilization of the cells or pores and secondly improving the flow of the reaction mixture. In this way, uniformly structured and fine-celled porous layers composed of polyurethane can be produced. In addition, they make it possible to provide particularly low-emission porous polyurethane layers.

The present invention thus provides for the use of at least one silicon-containing compound in the production of porous polyurethane layers, wherein the silicon-containing compound has the formula (1)

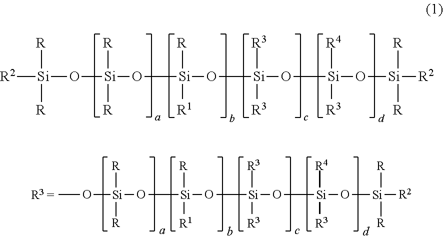

where

a is independently from 0 to 500, preferably from 1 to 300 and especially from 2 to 150,

b is independently from 0 to 60, preferably from 1 to 50 and especially from 1 to 30,

c is independently from 0 to 10, preferably from 0 or >0 to 5,

d is independently from 0 to 10, preferably from 0 or >0 to 5,

with the proviso that, for each molecule of the formula (1), the average number Σd of T units and the average number Σc of Q units per molecule is not greater than 50 in either case, the average number Σa of D units per molecule is not greater than 2000 and the average number Σb of the siloxy units bearing R¹ per molecule is not greater than 100,

R is independently at least one radical from the group of linear, cyclic or branched, aliphatic or aromatic, saturated or unsaturated hydrocarbon radicals having from 1 up to 20 carbon atoms, but is preferably a methyl radical,

R² is independently R¹ or R,

R¹ is different from R and is independently an organic radial and/or a polyether radical, R¹ is preferably a radical selected from the group consisting of

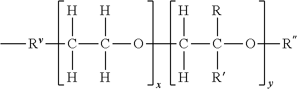

—CH₂—CH₂—CH₂—O—(CH₂—CH₂O—)ₓ—(CH₂—CH(R′)O—)y—R″_{y}—R″
—CH₂—CH₂—O—(CH₂—CH₂O—)ₓ—(CH₂—CH(R′)O—)_{y}—R″
—O—(C₂H₄O—)ₓ—(C₃H₅O—)_{y}—R′
—CH₂—R^{IV}
—CH₂—CH₂—(O)_{x′}—R^{IV}
—CH₂—CH₂—CH₂—O—CH₂—CH(OH)—CH₂OH

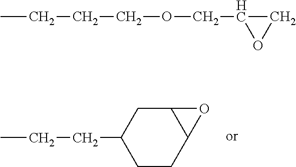

—CH₂—CH₂—CH₂—O—CH₂—C(CH₂OH)₂—CH₂—CH₃,

where

x is from 0 to 100, preferably >0, especially from 1 to 50,

x′ is 0 or 1,

y is 0 to 100, preferably >0, especially from 1 to 50,

R′ is independently an optionally substituted alkyl or aryl group having from 1 to 12 carbon atoms, substituted, for example, by alkyl radicals, aryl radicals or haloalkyl or haloaryl radicals, where different R′ substituents may be present within any R¹ radical and/or any molecule of the formula (1), and

R″ is independently a hydrogen radical or an alkyl group having from 1 to 4 carbon atoms, a C(O)—R″′ group with R′″=alkyl radical, a —CH2—O—R′ group, an alkylaryl group, for example a benzyl group, or a —C(O)NH—R′ group,

R^{IV} is a linear, cyclic or branched, optionally substituted, e.g. substituted by halogens, hydrocarbon radical having from 1 to 50, preferably from 9 to 45, more preferably from 13 to 37, carbon atoms,

R^{V} —D—G_{z}—
where D is a linear, cyclic or branched, optionally substituted, e.g. substituted by heteroatoms such as O, N or halogens, saturated or unsaturated hydrocarbon radical having from 2 to 50, preferably from 3 to 45, more preferably from 4 to 37, carbon atoms, G corresponds to one of the following formulae

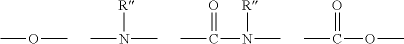

z can be 0 or 1,
where R¹ can also be bridging in the sense that two or three siloxane structures of the formula (1) can be joined via R¹, in which case R″ or R^{IV} are correspondingly bifunctional groups, i.e. R^{V},

R⁴ may independently be R, R¹ and/or a functionalized, organic, saturated or unsaturated radical having substitution by heteroatoms, selected from the group of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl and vinyl radical,

with the proviso that at least one substituent from R¹, R² and R⁴ is not R.

R³ is the siloxane side chain which can be formed by T and Q units. Since it is not possible to control precisely where these branching points are located, R³ once again occurs for R³ in the formula (1). It is thus possible to obtain hyperbranched structures as in the case of, for example, dendrimers.

The various monomer units in the structural units specified in the formulae (siloxane chains and/or polyoxyalkylene chain) may take the form of alternating blocks with any number of blocks in any sequence or be subject to a random distribution. The indices used in the formulae should be regarded as statistical averages.

This subject matter of the invention makes it possible to improve the flow properties of the reaction mixture which reacts to form the polyurethane layer and at the same time to optimize the cells of the resulting polyurethane layer, in particular by homogenization of the cell structure over the entire resulting polyurethane layer, which is particularly low in emissions, preferably in the context of artificial leather or foam film production.

The polyurethane layers of the invention can be used, in particular, in the fabrication of outer clothing, bags, material for shoe uppers, tent sheets, awnings, upholstery and many other articles, especially in the automobile sector.

The concept of the porous polyurethane layer is known per se. It is a contiguous, in particular flexible, sheet structure which has hollow spaces (also referred to as pores or cells) and is based on polyurethane. The hollow spaces are preferably filled with air. Depending on whether the pores can (≧20 μm) or cannot (≦20 μm) be discerned with the naked eye, a distinction is made between coarse pores and fine pores, with the latter being subdivided into macropores (>50 nm), mesopores (2-50 nm) and micropores (<2 nm). Open pores are communicated with the surrounding medium, while closed pores are closed off in themselves and do not allow any medium to penetrate. Instead of the term “layer”, it is also possible, for example, to use the term “film”, “coating” or “sheet”.

In a preferred embodiment of the invention, the thickness of the polyurethane layer produced is in the range from 0.05 to 5 mm, preferably from 0.1 to 3 mm and in particular from 0.15 to 1 mm.

The siloxanes of the formula (1) can be prepared by known methods, for example the noble metal-catalyzed hydrosilylation reaction of compounds containing a double bond with corresponding hydrosiloxanes, as described, for example, in EP 1520870 A1. The cited document EP 1520870 A1 is hereby incorporated herein as reference and shall be deemed part of the disclosure of the present invention.

Compounds having at least one double bond per molecule used may, for example, be a-olefins, vinyl polyoxyalkylenes and/or allyl polyoxyalkylenes. Preference is given to using vinyl polyoxyalkylenes and/or allyl polyoxyalkylenes. Particularly preferred vinyl polyoxyalkylenes are, for example, vinyl polyoxyalkylenes having a molar mass in the range from 100 g/mol to 5,000 g/mol, which may be formed from the monomers propylene oxide, ethylene oxide, butylene oxide and/or styrene oxide in blocks or in random distribution, and which may either be hydroxy-functional or end-capped by a methyl ether function or an acetoxy function. Particularly preferred allyl polyoxyalkylenes are, for example, allyl polyoxyalkylenes having a molar mass in the range from 100 g/mol to 5,000 g/mol, which may be formed from the monomers propylene oxide, ethylene oxide, butylene oxide and/or styrene oxide in blocks or in random distribution, and which may either be hydroxy-functional or end-capped by a methyl ether function or an acetoxy function. Particular preference for use as compounds having at least one double bond per molecule is given to the exemplified a-olefins, allyl alcohol, 1-hexenol, vinylpolyoxyalkylenes and/or allylpolyoxyalkylenes and also allyl glycidyl ether and vinylcyclohexene oxide.

It is likewise possible to use compounds having more than one hydrosilylable double bond, as a result of which crosslinked siloxane structures in which a plurality of siloxane chains are joined to one another are formed. Compounds of this type are, for example, 1,3-divinyltetramethyldisiloxane, 1,7-octadiene, diallylpolyoxyalkylene glycols, dimethallylpolyoxyalkylene glycols, polyalkylene glycol bis(acrylate) or trimethylolpropane diallyl ether, triallyl isocyanurate. Further suitable compounds are, for example, esters such as allyl methacrylate, allyl acrylate, diallyl adipate, methallyl acrylate, methallyl methacrylate, vinyl acrylate, vinyl methacrylate, ethylene dimethacrylate, tetramethylene diacrylate and pentaerythritol tetramethacrylate and also, for example, ethers such as glycol divinyl ether, divinyl adipate, allyl vinyl ether, diallyl fumarate, triallyl cyanurate and trimethylolpropane triallyl ether.

Siloxane structures of this type are also described in the following patent documents, but these describe the use only in classical polyurethane foams, as moulded foam, mattress, insulation material, construction foam, etc: CN103665385, CN103657518, CN103055759, CN103044687, US 2008/0125503, EP 1520870 A1, EP 1211279, EP 0867464, EP 0867465, EP 0275563. These documents are hereby incorporated by reference and are considered to form part of the disclosure of the present invention.

Preference is given to using, in the context of the present invention, siloxanes of the formula (1) in which a is independently from 1 to 300, b is independently from 1 to 50, c is independently from 0 to 4, for example from >0 to 4, d is independently from 0 to 4, for example from >0 to 4, with the proviso that, for each molecule of the formula (1), the average number Σd of T units and the average number Σc of Q units per molecule is not greater than 20, the average number Σa of D units per molecule is not greater than 1500 and the average number Σb of R¹-bearing siloxy units per molecule is not greater than 50. This corresponds to a preferred embodiment of the invention.

In a preferred embodiment of the present invention, here and in the following referred to as variant A for systematic reasons, use is made of siloxanes of the formula (1) in which R¹ is independently an organic radical selected from the group consisting of

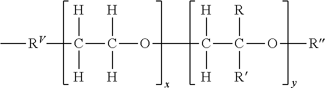

—CH₂—CH₂—CH₂—O—(CH₂—CH₂O—)ₓ—(CH₂—CH(R′)O—)_{y}—R″

—CH₂—CH₂—O—(CH₂—CH₂O—)ₓ—(CH₂—CH(R′)O—)_{y}—R″

—CH₂—R^{IV},

where

x is from 0 to 100, preferably >0, especially from 1 to 50,

y is from 0 to 100, preferably >0, especially from 1 to 50, the radicals R′ can independently be different and are methyl, ethyl and/or phenyl radicals,

R″ is independently a hydrogen radical or an alkyl group having from 1 to 4 carbon atoms, a C(O)—R″′ group with R″′=alkyl radical, a —CH₂—O—R′ group, an alkylaryl group, for example a benzyl group, the —C(O)NH—R′ group,

R^{IV} is a linear, cyclic or branched, optionally substituted, e.g. substituted by halogens, hydrocarbon radical having from 1 to 50, preferably from 9 to 45, more preferably from 13 to 37, carbon atoms,

where R¹ can also be bridging in the sense that two or three siloxane structures of the formula (1) can be joined to one another via R¹. In this case, R″ or R^{IV} are correspondingly bifunctional groups, i.e. R^{V} with R^{V} as defined above. Constituents of the formula not specified here, for example a, b, R^{V}, R¹, etc. are as defined above.

In a preferred embodiment of the present invention, referred to here and in the following as variant B for systematic reasons, use is made of siloxanes of the formula (1) in which the indices c and d are equal to zero. In such a case, no branched (or branching) siloxane units are present. In this case, variant B, the siloxanes can be described by the formula 2:

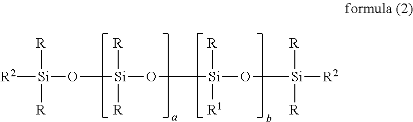

For the constituents of the formula which are not specified here, for example a, b, etc., the abovementioned definitions apply.

In a further preferred embodiment of the present invention, referred to here and in the following as variant C for systematic reasons, use is made of siloxanes of the formula (1), preferably formula (2), in which R¹ can also be bridging in the sense that two or more siloxane structures of the formula (2) can be joined to one another via one or more R¹ radicals. In this case, R″ or R^{IV} are correspondingly bifunctional groups, i.e. R^{V}.

This can, for example, be illustrated by the following structural element:

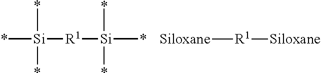

In this case of the variant C, the siloxanes can, in particular, be described by formulae 3a, b and/or c (formulae 3a, b and/or c summarized in the interest of simplicity=formula 3). Various structure types are obtained, depending on how many crosslinking radicals R¹ are used and in which position:

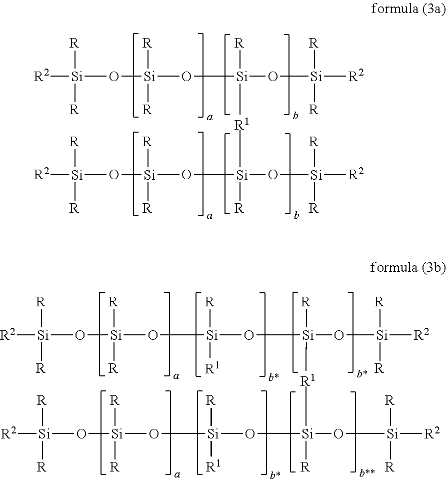

where b*+b**=b,

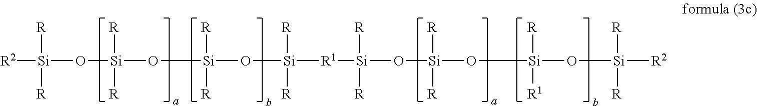

Constituents of the formula which are not specified in the formulae 3a to c, for example a, b, etc., are as defined above.

In a further preferred embodiment of the present invention, referred to here and in the following as variant D for systematic reasons, use is made of siloxanes of the formula (1 to 3) in which R¹ is as described under variant A with the proviso that the mole fraction of oxyethylene units based on the total amount of oxyalkylene units is at least 70 eq. % of the oxyalkylene units, i.e. x/(x+y) is >0.7. Constituents of the formula not specified here are as defined above.

In a further preferred embodiment of the present invention, referred to here and in the following as variant E for systematic reasons, use is made of siloxanes of the formula (1 to 3) in which R¹ is as in variant A and

one organic radical is independently selected from the group consisting of —CH2—CH2—CH2—O—(CH2—CH2O—)x—(CH2—CH(R′)O—)y—R″ and/or

—RV—O—(CH2—CH2O—)x—(CH2—CH(R′)O—)y—R″ and/or

—CH2—CH2—O—(CH2—CH2O—)x—(CH2—CH(R′)O—)y—R″ and/or

—CH2—R^{IV},

with the proviso that x is from 0 to 100, preferably >0, in partiuclar from 1 to 50, y is from 0 to 100, preferably >0, in partiuclar from 1 to 50, R′ is methyl and R″ is independently a hydrogen radical or an alkyl group having from 1 to 4 carbon atoms, a C(O)—R′″ group where R″′=alkyl radical, a —CH2—O—R′ group, an alkylaryl group such as a benzyl group, the group C(O)NH—R′, where the mole fraction of oxyethylene units based on the total amount of oxyethylene units is not more than 60 eq. % of the oxyalkylene units, i.e. x/(x+y) is <0.6. Constituents of the formula which are not specified here are as defined above.

In a further preferred embodiment of the present invention, referred to here and in the following as variant F for systematic reasons, use is made of siloxanes of the formula (1) in which at least 80%, particularly preferably at least 90%, of the radicals R″ are hydrogen. Constituents of the formula not specified here are as defined above. Constituents of the formula not specified here are as defined above.

In a further preferred embodiment of the present invention, referred to here and in the following as variant G for systematic reasons, use is made of siloxanes of the formula (1) in which from 30 to 80%, particularly preferably from 40 to 70%, of the radicals R″ are hydrogen. Constituents of the formula not specified here are as defined above.

In a further preferred embodiment of the present invention, referred to here and in the following as variant H for systematic reasons, use is made of siloxanes of the formula (1) in which not more than 20%, particularly preferably not more than 10%, of the radicals R″ are hydrogen. Constituents of the formula not specified here are as defined above.

In a further preferred embodiment of the present invention, referred to here and in the following as variant J for systematic reasons, use is made of siloxanes of the formula (1) in which, inter alia, olefins are used in the hydrosilylation, as a result of which R¹ consists to an extent of at least 10 mol %, preferably at least 20 mol %, particularly preferably at least 40 mol %, of CH₂—R^{IV}, where R^{IV} is a linear or branched hydrocarbon having from 9 to 17 carbon atoms. Constituents of the formula not specified here are as defined above.

In a further preferred embodiment of the present invention, referred to here and in the following as variant K for systematic reasons, use is made of siloxanes of the formula (1 to 3) in which the terminal positions, also referred to as alpha and omega positions, on the siloxane are at least partly functionalized by R¹ radicals. In fact, at least 10 mol %, preferably at least 30 mol % and more preferably at least 50 mol % of the terminal positions are functionalized by R¹ radicals. Constituents of the formula which are not specified here are as defined above.

In a particularly preferred embodiment of the invention, referred to here and in the following as variant L for systematic reasons, use is made of siloxanes of the formula (1 to 3) in which, on a statistical average, not more than 70%, preferably not more than 65%, particularly preferably not more than 60%, of the total average molecular weight of the siloxane is made up by the totalled molar mass of all, optionally different, radicals R¹ in the siloxane. Constituents of the formula which are not specified here are as defined above.

In a preferred form of the invention, referred to here and in the following as variant M for systematic reasons, not more than 30 eq. %, particularly preferably not more than 20 eq. %, more preferably not more than 15 eq. %, of the radicals R¹ are bifunctional groups. Such siloxane structures are described in EP 0867465. Constituents of the formula which are not specified here are as defined above.

In a further preferred embodiment of the present invention, referred to here and in the following as variant N for systematic reasons, use is made of siloxanes of the formula (1 to 3) in which the radical R is methyl and the number of structural elements having the index a is greater than the number of the structural elements having the index b, so that the ratio a/b is at least four, preferably greater than five, particularly preferably greater than seven. Constituents of the formula which are not specified here are as defined above.

In a further preferred embodiment of the present invention, referred to here and in the following as variant P for systematic reasons, use is made of siloxanes of the formula (1 to 3) in which the radical R is methyl and the sum of the D units (Σa) and units bearing R1 (Σb), i.e. (Σa+Σb), is greater than 15, preferably greater than 25, very particularly preferably greater than 45. Constituents of the formula which are not specified here are as defined above.

In further particularly preferred embodiments of the invention, use is made of siloxanes of the formula (1-3) whose structures combine the following variants:

Variant A combined with the variants B, D and F

Variant A combined with the variants C, E and H

Variant A combined with the variants C, E and M

Variant A combined with the variants B, D, F and P

Variant A combined with the variants E, H and M

Variant J with the variant K

Variant F with the variant K

Variant G with the variant K

Variant D combined with the variants F and K

Variant D combined with the variants F, K, L and N

Variant A combined with the variants B, E, G and P

Variant A combined with the variants B, E, H and P

Variant A combined with the variants B, E, F and P

Variant A combined with the variants B, D, N and P

Variant K with the variant M

Variant D combined with the variants F, K and M

Variant E combined with the variants H, K and M.

Each one of the abovementioned variant combinations corresponds to a particularly preferred embodiment of the invention.

The last preferred embodiment of the invention mentioned, viz. the combination of variants E, H, K and M, is thus characterized especially by the following. Particular preference is given to using siloxanes of the formula (1) in which

the mole fraction of oxyethylene units based on the total amount of oxyalkylene units is not more than 60 eq. % of the oxyalkylene units, i.e. x/(x+y) is <0.6,

not more than 20%, particularly preferably not more than 10%, of the radicals R″ are hydrogen, and in which the terminal positions, also referred to as alpha and omega positions, on the siloxane are at least partly functionalized by radicals R¹, where at least 10 mol %, preferably at least 30 mol %, particularly preferably at least 50 mol %, of the terminal positions are functionalized by radicals R¹,

and not more than 30 eq. %, particularly preferably not more than 20 eq. %, more preferably not more than 15 eq. %, of the radicals R¹ are bifunctional groups. Constituents of the formula which are not specified here are as defined above.

In a further preferred embodiment of the invention, the use according to the invention is characterized in that the total amount of the silicon-containing compound(s) of the formula (1) which is/are used is such that the proportion by mass of compounds of the formula (1) based on the finished polyurethane is from 0.01 to 10% by weight, preferably from 0.1 to 3% by weight.

The siloxanes of the invention can, in the context of the present invention, especially in the context of the use according to the invention, also be used as part of compositions with different carrier media. Possible carrier media are, for example, glycols, alkoxylates or oils of synthetic and/or natural origin.

Likewise, Si-free surfactants can also be used in addition to the siloxanes of the invention. These can, non-ionic, anionic, cationic or amphoteric materials such as fatty acid polyglycol esters, fatty alcohol alkoxylates, fatty amine alkoxylates, alkoxylation products having amphiphilic properties, alkylphenol alkoxylates, polyglycerol derivatives, fatty acid amides, sorbitan ethers, sorbitan esters, sorbitol ethers, sorbitol esters, sulphonic acid derivatives, sulphate esters, phosphoric esters, sulphosuccinamates, ammonium salts, quaternary ammonium compounds, betaines, amphoacetates, alkyl sulphates, alkyl ether sulphates, arylsulphonates, alkylarylsulphonates, alkanesulphonates, esters of phosphoric acid, phosphonic acid or phosphinic acid, acyl glutamates, amine oxides, ether carboxylates, isethionates, methyl taurates, sarcosinates, isethionates, sulphosuccinates, etc.

In a further preferred embodiment of the invention, a solvent-free or low-solvent process is used in the production according to the invention of the porous polyurethane layer.

For the purposes of the present invention, a “low-solvent process” is a production process which takes place using very small amounts of solvent. This means that it is advantageous to use less than 35% by weight, more advantageously less than 25% by weight, preferably less than 10% by weight, particularly preferably less than 5% by weight, of solvent in the production of the porous PU layer, where the % by weight is based on the total reaction mixture, i.e. including optional materials such as fillers. A lower limit for the solvent can be, for example, 0.1% by weight or, for example, 1% by weight.

For the purpose of the present invention, a “solvent-free process” is a production process which takes place without solvents.

Useful solvents are all substances suitable according to the prior art. Depending on the application, it is possible to use, for example, aprotic nonpolar, aprotic polar and/or protic solvents.

In a further preferred embodiment of the invention, chemically blocked, preferably oxime-blocked, NCO prepolymers and crosslinkers, preferably comprising aliphatic and/or cycloaliphatic and/or aromatic amines having at least two primary and/or secondary amino groups, are used for producing the porous polyurethane layer. Here, polyols are reacted with polyfunctional isocyanates in order to obtain an isocyanate prepolymer. The free NCO-functions are then preferably reacted with oximes. The oximes can be eliminated again by heating so as to set the NCO group free again. Thus, a reaction mixture consisting of blocked isocyanates and amines can be cured, especially by heating, advantageously at about 100-190° C., preferably 120-170° C. EP 0431386A2 describes a typical process of this type.

Blocking agents for the NCO prepolymers are all compounds which are known per se from polyurethane chemistry for masking NCO groups and which are eliminated again on heating, e.g. to above about 100° C., to set the isocyanate groups free again, for example ketoximes derived from hydroxylamine and ketones such as acetone, methyl ethyl ketone, diethyl ketone, methyl propyl ketone, methyl isopropyl ketone, methyl isobutyl ketone, cyclohexanone, acetophenone and benzophenone. Furthermore, alkyl esters of acetic acid and of malonic acid, e.g. ethyl acetate and diethyl malonate, lactams, such as caprolactam and phenols such as nonylphenol are also suitable as blocking agents. According to the invention, preference can be given to using, for example, prepolymers derived from polypropylene glycol ethers or propoxylated bisphenol A and tolylene diisocyanate and/or diphenylmethane diisocyanate which are blocked with methyl ethyl ketoxime (butanone oxime).

For crosslinking, it is possible to use, in particular, aliphatic and/or cycloaliphatic and/or aromatic amines having at least two primary and/or secondary amino groups. Such amines are, for example, ethylenediamine, diethylenetriamine, 1,2-propylenediamine, 1,3-propylenediamine, 1,6-hexanediamine, N-methylbis(3-aminopropyl)amine, 1,3 and 1,4--cyclohexanediamine, isophoronediamine, 4,4′-diaminodicyclohexylmethane, the isomeric 4,4′-diaminodimethyldicyclohexylmethanes, 4,4′-diaminodiphenylmethane, diethyltolylenediamine, but preferably amines which are liquid at room temperature and tricyclic diamines. It is likewise possible to use aromatic amines such as 4,4′-methylenebis(2-chloroaniline). The ratio of equivalents between NH2 groups and blocked NCO groups in the reaction mixture is advantageously in the range from 1.1:1.0 to 0.7:1.0, preferably from 1.0:1.0 to 0.8:1.0, particularly preferably about 0.9:1.0.

In a further preferred embodiment of the invention, a component having at least two isocyanate-reactive groups, preferably a polyol component, a catalyst and a polyisocyanate and/or a polyisocyanate prepolymer are used for producing the porous polyurethane layer. Here, the catalyst is, in particular, introduced via the polyol component. Suitable polyol components, catalysts and polyisocyanates and/or polyisocyanate prepolymers are described further below.

In the production according to the invention of the porous polyurethane layer, the reaction mixtures used can optionally additionally comprise further constituents such as polymer dispersions, polyamines, pigments or other colour-imparting components, UV stabilizers, antioxidants, feel-influencing agents such as silicones, cellulose esters, fillers such as chalk or barite, etc. Suitable polymer dispersions are, for example, polyurethane dispersions, aqueous latices of homopolymers and copolymers of vinyl monomers and optionally dienes and also aqueous dispersions of nitrocellulose solutions, as are known per se from leather finishing. Polymer dispersions which are preferred for the purposes of the invention are, for example, those derived from butyl acrylate, styrene, acrylonitrile, acrylamide, acrylic acid and N-methylolacrylamide and also optionally butadiene. Polymer latices which can be used for the purposes of the invention can, for example, be made up of the following monomers: Acrylic and methacrylic esters of methanol, ethanol or butanol, vinyl chloride, vinylidene chloride, vinyl acetate, vinyl alcohol (by partial hydrolysis of polyvinyl acetate), ethylene, propylene, acrylonitrile, styrene, butadiene, isoprene, chloroprene; also acrylamide, N-methylolacrylamide, methacrylamide, acrylic acid and methacrylic acid.

The invention further provides a process for producing porous polyurethane layers, where the layer thickness is advantageously in the range from 0.05 to 5 mm, preferably from 0.1 to 3 mm and in particular from 0.15 to 1 mm,

wherein a reactive composition which is capable of forming a polyurethane and comprises chemically blocked, preferably oxime-blocked, NCO prepolymers and crosslinkers, preferably comprising aliphatic and/or cycloaliphatic and/or aromatic amines having at least two primary and/or secondary amine groups, is reacted,

with the reaction leading to the formation of the porous polyurethane layer being carried out in the presence of a silicon-containing compound of the formula (1).

The invention further provides a process for producing porous polyurethane layers, where the layer thickness is advantageously in the range from 0.05 to 5 mm, preferably from 0.1 to 3 mm and in particular from 0.15 to 1 mm,

wherein a reactive composition which is capable of forming a polyurethane and contains

i) a polyol having primary and/or secondary terminal hydroxy functions,

ii) a polyisocyanate and/or a polyisocyanate prepolymer, and

iii) a catalyst,

is reacted,

with the reaction leading to the formation of the porous polyurethane layer being carried out in the presence of a silicon-containing compound of the formula (1).

The invention further provides a porous polyurethane layer obtainable by the use according to the invention or the process of the invention. The thickness of the polyurethane layer is advantageously in the range from 0.05 to 5 mm, preferably from 0.1 to 3 mm and in particular from 0.15 to 1 mm. The total amount of the silicon-containing compound(s) of the formula (1) which is used is, based on the finished polyurethane, preferably from 0.01 to 10% by weight, more preferably from 0.1 to 3% by weight.

The invention further provides a process for producing a composite structure comprising at least one porous polyurethane layer and a support layer,

wherein the at least one porous polyurethane layer is applied directly or indirectly to a support layer and the at least one polyurethane layer is formed by applying a reactive composition which is capable of forming a polyurethane to the support layer and curing this reactive composition, with the formation of the porous polyurethane layer being carried out in the presence of a silicon-containing compound of the formula (1).

In the process of the invention, stirring or dispersing apparatuses which generate high shear can be used, especially when no chemical foaming occurs, in order to introduce the necessary amount of gas into the reaction mixture. Such stirring or dispersing apparatuses are well known to those skilled in the art. These can be, for example, foam machines from the manufacturers Hansa, Oaxes, Ultraturrax, etc., or be appropriately modified laboratory stirrers which a person skilled in the art can choose with the aid of a few routine tests.

The invention further provides a process for producing porous polyurethane layers, where the layer thickness is advantageously in the range from 0.05 to 5 mm, preferably from 0.1 to 3 mm and in particular from 0.15 to 1 mm, wherein a reactive composition which is capable of forming a polyurethane is applied to a support material over an area and the formation of the porous polyurethane layer occurs in the presence of a silicon-containing compound of the formula (1).

The application over an area can preferably be brought about by doctor blade coating, which is known per se to those skilled in the art. A doctor blade makes it possible to produce a layer having a defined thickness, e.g. predetermined by the doctor blade gap, in a relatively simple way. This is referred to as application by doctor blade.

Suitable support layers are known per se to those skilled in the art and recourse can be made to all tried-and-tested, for example, films, woven fabrics, knitted or comparable structures composed of metals, plastics or natural fibres. In particular, natural fibres, chemical fibres and mixed woven fabrics can preferably be used as support layer.

Porous PU layers which are preferred for the purposes of the present invention have a density in kg/m³ in the range from preferably 100 to 1200, in particular from 200 to 1000, and advantageously a proportion of cells in % of preferably from 20 to 90, in particular from 30 to 80%. This corresponds to a preferred embodiment of the invention. This preferred embodiment also applies to the uses according to the invention, the process for producing the composite structures and the composite structures, in each case in respect of the preferred porous PU layers.

That the porous polyurethane layer is applied directly to a support layer means that these two layers adhere to one another without an intermediate layer. That the porous polyurethane layer is applied indirectly to a support layer means that these two layers are not in direct contact with one another but are instead joined to one another by means of an intermediate layer, e.g. a layer of adhesive.

A construction which is preferred according to the invention of a composite structure comprises, in order, a textile layer/bonding layer/porous polyurethane layer/unfoamed covering layer(s). On this subject, reference is made to EP 1059379 A2, where corresponding composite structures are described.

In a preferred embodiment of the invention, the process of the invention for producing a composite structure is characterized in that the reactive composition which is capable of forming a polyurethane comprises chemically blocked, preferably oxime-blocked, NCO prepolymers and crosslinkers, preferably comprising aliphatic and/or cycloaliphatic and/or aromatic amines having at least two primary and/or secondary amine groups.

In a further preferred embodiment of the invention, the process of the invention for producing a composite structure is characterized in that the reactive composition which is capable of forming a polyurethane comprises

i) a polyol having primary and/or secondary terminal hydroxy functions,

ii) a polyisocyanate and/or a polyisocyanate prepolymer, and

iii) a catalyst.

The invention further provides a composite structure comprising at least one porous polyurethane layer as described above in the context of the present invention and a support layer, wherein the two layers are indirectly or directly joined to one another.

The present invention further provides a composite structure obtainable by the process according to the invention, as described above.

The invention further provides for the use of the composite structure of the invention, as described above, as artificial leather or as foam film.

The invention further provides for the use of silicon-containing compounds of the formula (1) in the production of porous polyurethane layers, in particular as described above, for improving the flow properties of the reaction mixture which is reacting to form the polyurethane layer and/or for optimizing the cells of the resulting polyurethane layer, preferably for homogenizing the cell structure over the entire resulting polyurethane layer, especially in the context of artificial leather or foam film production.

The subject matter provided by the invention is illustratively described hereinbelow without any intention to limit the invention to these illustrative embodiments. Where ranges, general formulae or compound classes are specified hereinbelow, these are intended to include not only the relevant ranges or groups of compounds explicitly mentioned but also all subranges and subgroups of compounds that may be obtained by extracting individual values (ranges) or compounds. When documents are cited in the context of the present description, the contents thereof, particularly with regard to the subject-matter that forms the context in which the document has been cited, are considered in their entirety to form part of the disclosure content of the present invention. Unless stated otherwise, percentages are figures in per cent by weight. When average values are reported hereinbelow, the values in question are weight averages, unless stated otherwise. When parameters which have been determined by measurement are reported hereinafter, they have been determined at a temperature of 25° C. and a pressure of 101.325 Pa, unless stated otherwise.

For the purposes of the present invention, polyurethane (PU) is in particular a product obtainable by reaction of polyisocyanates and polyols or compounds having isocyanate-reactive groups. Further functional groups in addition to the polyurethane can also be formed in the reaction, examples being uretdiones, carbodiimides, isocyanurates, allophanates, biurets, ureas and/or uretimines. For the purposes of the present invention, the term PU therefore encompasses polyurethanes and polyisocyanurates, polyureas and polyisocyanate reaction products containing uretdione, carbodiimide, allophanate, biuret and uretone imine groups. For the purposes of the present invention, polyurethane foam (PU foam) is foam which is obtained as reaction product based on polyisocyanates and polyols or compounds having isocyanate-reactive groups. Further functional groups in addition to the polyurethane can also be formed in the reaction, examples being allophanates, biurets, ureas, carbodiimides, uretdiones, isocyanurates or uretone imines.

The compounds of the formula (1) which are to be used according to the invention are preferably used in a total proportion by mass of from 0.01 to 20.0 parts (pphp), more preferably from 0.01 to 5.00 parts and particularly preferably from 0.05 to 3.00 parts, based on 100 parts (pphp) of polyol component.

The isocyanate components used are preferably one or more organic polyisocyanates having two or more isocyanate functions. Polyol components used are preferably one or more polyols having two or more isocyanate-reactive groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Isocyanates are particularly preferably used in an amount of from 60 to 200 mol %, relative to the sum total of isocyanate-consuming components.

Specific examples are: alkylene diisocyanates having 4 to 12 carbon atoms in the alkylene moiety, for example 1,12-dodecane diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomeric mixtures, and preferably aromatic diisocyanates and polyisocyanates such as tolylene 2,4- and 2,6-diisocyanate (TDI) and the corresponding isomeric mixtures, naphthalene diisocyanate, diethyltoluene diisocyanate, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). Organic di- and polyisocyanates can be used individually or as mixtures thereof. It is likewise possible to use corresponding “oligomers” of the diisocyanates (IPDI trimer based on isocyanurate, biuret and uretdiones.) Furthermore, the use of prepolymers based on the abovementioned isocyanates is possible.

It is also possible to use isocyanates which have been modified by the incorporation of urethane, uretdione, isocyanurate, allophanate and other groups, called modified isocyanates.

Particularly suitable organic polyisocyanates, which are therefore particularly preferably employed, are various isomers of tolylene diisocyanate (tolylene 2,4- and 2,6-diisocyanate (TDI), in pure form or as isomer mixtures of different compositions), diphenylmethane 4,4′-diisocyanate (MDI), known as “crude MDI” or “polymeric MDI” (contains not only the 4,4′ isomer but also the 2,4′ and 2,2′ isomers of MDI and products having more than two rings) and also the two-ring product referred to as “pure MDI” which is composed predominantly of 2,4′- and 4,4′ isomer mixtures and/or prepolymers thereof. Examples of particularly suitable isocyanates are detailed, for example, in EP 1 712 578, EP 1 161 474, WO 00/58383, US 2007/0072951, EP 1 678 232 and WO 2005/085310, to which reference is made here in full.

Polyols suitable as polyol component for the purposes of the present invention are all organic substances having two or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, known as “natural oil-based polyols” (NOPs) which are customarily used for producing polyurethane systems, especially polyurethane coatings, polyurethane elastomers or foams. Typically, the polyols have a functionality of from 1.8 to 8 and number average molecular weights in the range from 500 to 15 000. Typically, the polyols having OH numbers in the range from 10 to 1200 mg KOH/g are used.

Polyether polyols are obtainable by known methods, for example by anionic polymerization of alkylene oxides in the presence of alkali metal hydroxides, alkali metal alkoxides or amines as catalysts and by addition of at least one starter molecule, which preferably contains 2 or 3 reactive hydrogen atoms in bonded form, or by cationic polymerization of alkylene oxides in the presence of Lewis acids such as, for example, antimony pentachloride or boron trifluoride etherate, or by double metal cyanide catalysis. Suitable alkylene oxides contain from 2 to 4 carbon atoms in the alkylene moiety. Examples are tetrahydrofuran, 1,3-propylene oxide, 1,2-butylene oxide and 2,3-butylene oxide; ethylene oxide and 1,2-propylene oxide are preferably used. The alkylene oxides can be used individually, cumulatively, in blocks, in alternation or as mixtures. Starter molecules used may especially be compounds having at least 2, preferably from 2 to 8, hydroxyl groups, or having at least two primary amino groups in the molecule. Starter molecules used may, for example, be water, dihydric, trihydric or tetrahydric alcohols such as ethylene glycol, 1,2-propane and -1,3-propanediol, diethylene glycol, dipropylene glycol, glycerol, trimethylolpropane, pentaerythritol, castor oil, etc., higher polyfunctional polyols, in particular sugar compounds such as glucose, sorbitol, mannitol and sucrose, polyhydric phenols, resols such as oligomeric condensation products of phenol and formaldehyde and Mannich condensates of phenols, formaldehyde and dialkanolamines, and also melamine, or amines such as aniline, EDA, TDA, MDA and PMDA, particularly preferably TDA and PMDA. The choice of the suitable starter molecule is dependent on the respective field of application of the resulting polyether polyol in the production of polyurethane.

Polyester polyols are based on esters of polybasic aliphatic or aromatic carboxylic acids, preferably having from 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having from 2 to 12, more preferably having from 2 to 6, carbon atoms, preferably trimethylolpropane and glycerol.

Polyether polycarbonate polyols are polyols containing carbon dioxide in the bonded form of the carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO₂ as comonomer is very advantageous in environmental terms, since this reaction constitutes the conversion of a greenhouse gas to a polymer. The preparation of polyether polycarbonate polyols by addition of alkylene oxides and carbon dioxide onto H-functional starter substances by use of catalysts is well known. Various catalyst systems can be used here: The first generation was that of heterogeneous zinc or aluminium salts, as described, for example, in U.S. Pat. No. 3,900,424 or U.S. Pat. No. 3,953,383. In addition, mono- and binuclear metal complexes have been used successfully for copolymerization of CO2 and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols based on renewable raw materials, natural oil-based polyols (NOPs), for production of polyurethane foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now available on the market from various manufacturers (WO 2004/020497, US 2006/0229375, WO 2009/058367). Depending on the base raw material (e.g. soya bean oil, palm oil or castor oil) and the subsequent workup, polyols having a different profile of properties are the result. It is possible here to distinguish essentially between two groups: a) polyols based on renewable raw materials which are modified such that they can be used to an extent of 100% for production of polyurethanes (WO 2004/020497, US 2006/0229375); b) polyols based on renewable raw materials which, because of the workup and properties thereof, can replace the petrochemical-based polyol only in a certain proportion (WO 2009/058367).

A further class of usable polyols is that of the so-called filled polyols (polymer polyols). A feature of these is that they contain dispersed solid organic fillers up to a solids content of 40% or more. SAN, PUD and PIPA polyols are among useful polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of usable polyols is that of those which are obtained as prepolymers by reaction of polyol with isocyanate in a molar ratio of from 100:1 to 5:1, preferably from 50:1 to 10:1. Such prepolymers are preferably made up in the form of a solution in polymer, and the polyol preferably corresponds to the polyol used for preparing the prepolymers.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 10 to 1000 and preferably in the range from 40 to 350. An index of 100 represents a molar ratio of 1:1 for the reactive groups.

Catalysts which are suitable for the purposes of the present invention are all compounds which are able to accelerate the reaction of isocyanates with OH functions, NH functions or other isocyanate-reactive groups. Here, recourse can be made to the customary catalysts known from the prior art, encompassing, for example, amines (cyclic, acyclic; monoamines, diamines, oligomers having one or more amino groups), metal organic compounds and metal salts, preferably those of tin, iron, bismuth and zinc. In particular, it is possible to use mixtures of a plurality of components as catalysts.

The use of blowing agents is optional, depending on which foaming process is used. In mechanical foaming, an inert gas (air, nitrogen, carbon dioxide) is introduced into the reaction mixture by means of specific stirring apparatuses, so that it is in this case also possible to work without further physical or chemical blowing agents.

However, chemical and physical blowing agents can also be employed.

The choice of the blowing agent here depends greatly on the type of system. Thus, in the case of blocked high-solid systems, solids which decompose at the curing temperatures of from 140 to 180° C. and thus form cells are usually dispersed in. Encapsulated blowing agents such as “microspheres” from Akzo Nobel are also used.

When curing takes place at relatively low temperatures, compounds of this type having appropriate boiling points can be used. It is likewise possible to use chemical blowing agents which react with NCO groups to liberate gases, for example water or formic acid.

These are, for example, liquefied CO₂, and volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFO) or hydrohaloolefins, for example 1234ze, 1233zd(E) or 1336mzz, oxygen compounds such as methyl formate, acetone and dimethoxymethane, or chlorinated hydrocarbons, preferably dichloromethane and 1,2-dichloroethane.

As additives, it is possible to use all substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, colour pastes, fragrances, and emulsifiers.

The examples presented below illustrate the present invention by way of example, without any intention of restricting the invention, the scope of application of which is apparent from the entirety of the description and the claims, to the embodiments specified in the examples.

### EXAMPLES

Materials Used:

Polyether Siloxanes According to the Invention

Impranil® HS 62 from Bayer Materialscience

Imprafix® HS-C from Bayer Materialscience

Voranol® CP 3322 from DOW (polyether triol having an OH number of 47 mg KOH/g)

Arcol® 1374 from Bayer Materialscience (polyether polyol having an OH number of 28 mg KOH/g)

Polyether PPG 2470 from Evonik Industries AG

Kosmos® 54 from Evonik Industries AG (catalyst based on zinc ricinoleate)

Monoethylene glycol from Dow

Desmophen® 2200 from Bayer Materialscience (aliphatic polycarbonate diol)

Desmodur® VP PU 0129 from Bayer Materialscience (mixture of 60% of diphenylmethane 2,4′-diisocyanate and 40% of diphenylmethane 4,4′-diisocyanate)

Desmodur® 44V20L from Bayer Materialscience (mixture of diphenylmethane 4,4′-diisocyanate (MDI) with isomeric and higher-functionality homologues)

Siliconized release paper from Sappi

Desmodur® T 80 (TDI) from Bayer Materialscience (toluylene 2,4- and 2,6-diisocyanate (TDI) in a ratio of 80 : 20)

### Example 1

### Preparation of the Siloxanes

Siloxanes of the formula (1) according to the invention are prepared according to the processes known in the prior art by reacting corresponding hydrogen siloxanes by hydrosilylation. Allyl polyethers, vinyl polyethers, olefins and also compounds having a plurality of unsaturated groups were reacted to form compounds of the formula 1. The preparation was carried out by a method analogous to Example 7 in DE 1020070554852 and thus corresponding to the prior art for preparing SiC-bonded polyether siloxanes, as described, for example, in EP 1520870 and EP 0867465.

The polyethers used are summarized in Table 1.

TABLE 1
Polyethers used for preparing the compounds in Table 2

| Polyether | Starter | R″ | x= | y= |
|---|---|---|---|---|
| PE 1 | Allyl alcohol | —H | 12 | 0 |
| PE 2 | Allyl alcohol | —H | 10 | 2 |
| PE 3 | Allyl alcohol | —H | 12.5 | 3.5 |
| PE 4 | Allyl alcohol | —H | 14.5 | 7 |
| PE 5 | Hydroxyethyl | —CH₃ | 16 | 8 |
| | vinyl ether | | | |
| PE 6 | Allyl alcohol | —Me | 12.7 | 13.5 |
| PE 7 | Allyl alcohol | —H | 20 | 4.5 |
| PE 8 | Allyl alcohol | —CH₃ | 10 | 0 |
| PE 9 | Allyl alcohol | —H | 35.5 | 37.5 |
| PE 10 | Allyl alcohol | —H | 3.7 | 20.4 |
| PE 11 | Allyl alcohol | —Me | 9.8 | 15.7 |
| PE 12 | Allyl alcohol | —Me | 14.2 | 3.8 |
| PE 13 | Allyl alcohol | —H | 35.5 | 37.5 |
| PE 14 | Allyl alcohol | —H | 10.7 | 8.2 |

(x = ethylene oxide units,
y = propylene oxide units,
R″ = end group)

The structure of the siloxane compounds (SC) obtained can be seen from Table 2. The parameters shown in Table 2 relate to the abovementioned formula (1).

TABLE 2
Compositions of the silicon-containing compounds
(SC) of the formula (1).

| SV | R | Σa | R¹ | R⁴ | Σb | Σc | Σd | R² |
|---|---|---|---|---|---|---|---|---|
| Comp. 2 | CH₃ | 4 | PE 8 | CH₃ | 4 | 0 | 0 | R |
| | | | PE 12)³ | | | | | |
| Comp. 3 | CH₃ | 20 | PE 12 | CH₃ | 5 | 0 | 0 | R |
| 1 | CH₃ | 38 | PE 1 | CH₃ | 10 | 0 | 0 | R |
| 2 | CH₃ | 20 | PE 1 | CH₃ | 2 | 0 | <<0.1 | R |
| 3 | CH₃ | 18 | PE 3 | CH₃ | 0 | 0 | <<0.1 | R¹ |
| 4 | CH₃ | 18 | PE 1 | CH₃ | 5 | 0 | <<0.1 | R¹ |
| 5 | CH₃ | 71 | PE 9 | CH₃ | 4 | 0 | <<0.1 | R |
| | | | PE 11 | | | | | |
| | | | PE 13)¹ | | | | | |
| 6 | CH₃ | 38 | PE 2 | CH₃ | 10 | 0 | 0 | R |
| | | | PE 7 | | | | | |
| | | | PE 14)² | | | | | |
| 7 | CH₃ | 42 | PE 6 | CH₃ | 6 | 0 | 0 | R |
| | | | V1)⁴ | | | | | |
| 8 | CH₃ | 8 | PE 8 | CH₃ | 10 | 0 | 0 | R |
| | | | PE 12)⁵ | | | | | |
| 9 | CH₃ | 50 | PE 4)⁶ | CH₃ | 8 | 0 | <<1 | R¹ |
| 10 | CH₃ | 50 | PE 5 | CH₃ | 8 | 0 | <<1 | R |
| 11 | CH₃ | 75 | PE 6 | CH₃ | 3 | 0 | <<1 | R¹ |
| | | | PE 9 | | | | | |
| | | | PE 10)⁷ | | | | | |
| 12 | CH₃ | 65 | PE 6 | CH₃ | 5 | 0 | <<1 | R¹ |
| | | | PE 9)⁸ | | | | | |
| 13 | CH₃ | 40 | PE 8 | CH₃ | 5 | 0 | <<1 | R |
| 14 | CH₃ | 40 | PE 4 | CH₃ | 3 | 0.5 | 2 | R¹ |
| 15 | CH₃ | 40 | PE 3 | CH₃ | 3 | 0 | 1 | R |
| | | | PE 4)⁹ | | | | | |
| 16 | CH₃ | 40 | PE 6 | C₈H₁₇ | 3 | 0.5 | 2 | R¹ |
| 17 | CH₃ | 55 | PE 5 | CH₃ | 6 | 0.5 | 2 | R¹ |
| 18 | CH₃ | 42 | PE 6 | CH₃ | 6 | 0 | 0 | R |
| | | | V1)¹⁷ | | | | | |
| 19 | CH₃ | 71 | PE 11 | CH₃ | 4 | 0 | <<0.1 | R |
| | | | PE 13 | | | | | |
| | | | V 2)¹⁰ | | | | | |
| 20 | CH₃ | 42 | PE 4 | CH₃ | 6 | 0 | 0 | R |
| | | | V1)¹¹ | | | | | |
| 21 | CH₃ | 42 | PE 3 | CH₃ | 6 | 0 | 0 | R |
| | | | V1)¹² | | | | | |
| 22 | CH₃ | 20 | PE 1 | CH₃ | 1 | 0 | <<0.1 | R¹ |
| 23 | CH₃ | 42 | PE 4 | CH₃ | 6 | 0 | 0 | R |
| | | | PE 6)¹³ | | | | | |
| 24 | CH₃ | 42 | PE 6 | CH₃ | 6 | 0 | 0 | R |
| 25 | CH₃ | 42 | PE 10 | CH₃ | 6 | 0 | 0 | R |
| 26 | CH₃ | 62 | PE 1 | CH₃ | 6 | 0 | 0 | R |
| | | | PE 7)¹⁴ | | | | | |
| 27 | CH₃ | 20 | PE 1 | CH₃ | 2 | 0 | <<0.1 | R¹ |
| | | | V1)¹⁵ | | | | | |
| 28 | CH₃ | 20 | PE 6 | CH₃ | 2 | 0 | <<0.1 | R¹ |
| | | | V1)¹⁵ | | | | | |

)¹ mixture consisting of 10 eq .% of PE 9 + 60 eq. % of PE 11 + 30 eq. % of PE 13
)² mixture consisting of 30 eq. % of PE 2 + 25 eq. % of PE 7 + 45 eq. % of PE 14
)³ mixture consisting of 50 eq. % of PE 8 + 50 eq. % of PE 12
)⁴ mixture consisting of 90 eq. % of PE 6 + 10 eq. % of V1 (crosslinker 1: Trimethylolpropane diallyl ether)
)⁵ mixture consisting of 70 eq. % of PE 8 + 30 eq. % of PE 12
)⁶ mixture consisting of 80 eq.% of PE 4 + 20 eq. % of C16-olefin
)⁷ mixture consisting of 60 eq. % of PE 6 + 20 eq. % of PE 9 + 20 eq. % of PE 10
)⁸ mixture consisting of 60 eq. % of PE 6 + 40 Äq. % of PE 9
)⁹ mixture consisting of 50 eq. % of PE 3 + 50 eq. % of PE 4
)¹⁰ mixture consisting of 10 eq. % of V 2 + 60 eq. % of PE 11 + 30 eq. % of PE 13; (crosslinker 2: Polyethylene glycol diallyl ether, MW = 400)
)¹¹ mixture consisting of 90 eq. % of PE 4 + 10 eq. % of V1 (crosslinker 1: Trimethylolpropane diallyl ether)
)¹² mixture consisting of 90 eq. % of PE 3 + 10 eq. % of V 1 (crosslinker 1: Trimethylolpropane diallyl ether)
)¹³ mixture consisting of 50 eq. % of PE 6 + 50 eq. % of PE 4
)¹⁴ mixture consisting of 50 eq. % of PE 1 + 50 eq. % of PE 7
)¹⁵ mixture consisting of 90 eq. % of PE 1 + 10 eq. % of V 1 (crosslinker 1: Trimethylolpropane diallyl ether)
)¹⁶ mixture consisting of 90 eq. % of PE 6 + 10 eq. % of V 1 (crosslinker 1: Trimethylolpropane diallyl ether)
)¹⁷ mixture consisting of 80 eq. % of PE 6 + 20 eq. % of V 1 (crosslinker 1: Trimethylolpropane diallyl ether)

In the comparative examples, use is made of:

Comp. 1: Dow Corning DC 193=polyether-modified methylpolysiloxane

Comp. 4: Baysilon® OL 17=polyether-modified methylpolysiloxane

Comp. 5: without Si-containing compound

Methods Used

Weighing Out

All weighings were carried out using a Sartorius CPA 3202S.

Mechanical Foaming

The batches were foamed by means of a stirrer in such a way that particularly good incorporation of air bubbles was ensured.

Viscosity Determination

The viscosities were determined using a Brookfield Digital Viscometer. A spindle LV 4 was used at 6 rpm. In the case of viscosities above 100 000 mPas, 3 rpm were used.

Production of the Porous Polyurethane Layers

The films were drawn using a film drawing apparatus AB 3320 from TQC.

Drying

Drying ovens from the companies Heraeus and Binder were used for drying.

Film Thickness Determination

The film thickness was measured using a digital sliding caliper, Holex 41 2811 150. The measurement is carried out at five places uniformly distributed over the film. The arithmetic mean was calculated from the results of the five repetitions and reported as measurement result.

Determination of the Weight Per Unit Area

The length and width of the films was measured using a ruler and the mass was determined using a Sartorius CPA 3202S. The weight per unit area was calculated according to the following equation (length l, width b, mass m).

$${m}_{A} = \frac{m}{l \cdot b}$$

Foam Density Determination

The thickness d of the films produced was measured. The density of the films ρ_{Film} was calculated therefrom:

$${ρ}_{Film} = \frac{{m}_{A}}{d}$$

Proportion of Cells

If the density of the unfoamed polyurethane ρ_{Bulk} is known, the percentage of cells Z can be calculated:

$$Z = ( 1 - \frac{{ρ}_{Film}}{{ρ}_{Bulk}} ) * 100 \%$$

The density of the raw materials was where necessary determined by a method based on DIN 51757.

Mechanical Data of the Films Produced

To determine the mechanical parameters, test specimens as shown in FIG. 1 were stamped from the films.

The measurement was carried out using a Zwick Roell Z010 tensile tester and a Zwick Roell KAF-TC load cell (nominal load 5 kN). The specimen was extended at a rate of advance of 500 mm/min. The elongation was recorded by means of strain gauges, at an initial length of 30 mm. The breaking stress σ_{br}, the elongation at break ε_{br} and the stress at 100% elongation σ_{100%} were determined.

A five-fold determination was carried out in each case. The arithmetic mean of the measurement results was calculated.

Scanning Electron Microscopy (SEM)

The images for microscopic evaluation were recorded using a Hitachi TM 3000 scanning electron microscope at a magnification of 250.

Macroscopic and Microscopic Assessment

For the macroscopic evaluation, the surface of the films were looked at without an aid. The flow properties, the cell homogeneity and the homogeneity over an area were assigned the grades from 1 (poor) to 5 (very good).

For the microscopic evaluation, images of the cross section of the films were recorded using a scanning electron microscope (SEM). The cell homogeneity, the cell size and the proportion of open cells were evaluated.

In order to summarize the individual aspects in a value for evaluation, the sum of the squares of the individual aspects was calculated.

Formulation 1: General Formulation Based on Capped Isocyanates

1000 parts of Impranil® HS62, 69 parts of Imprafix® HS-C and 20 parts of the respective silicon-containing compound according to the invention are stirred for 3 minutes at 1000 rpm by means of the abovementioned stirrer. The mixture is allowed to stand for 30 minutes.

Further Formulations Based on Uncapped Isocyanates

The constituents are stirred for 2 minutes at 2000 rpm by means of the abovementioned stirrer and subsequently processed further immediately.

TABLE 3
Formulations based on uncapped isocyanates

| | Formu- | Formu- | Formu- | Formu- |
|---|---|---|---|---|
| Constituents | lation 2 | lation 3 | lation 4 | lation 5 |
| Voranol ® CP 3322 | | | 50 | 90 |
| Arcol ® 1374 | 50 | 50 | | |
| Kosmos ® 54 | 0.2 | 0.2 | 0.2 | 0.2 |
| Monoethylene | | 10 | | 10 |
| glycol | | | | |
| Desmophen ® 2200 | 40 | | | |
| Polyether PPG 2470 | | 40 | 40 | |
| Desmodur ® VP PU | | 54 | | |
| 0129 | | | | |
| Dipropylene glycol | 10 | | 10 | |
| Desmodur ® | 28 | | 28 | |
| 44V20L | | | | |
| TDI | | | | 37 |
| Siloxane | 2 | 2 | 2 | 2 |

Production of the Porous Polyurethane Layers

The box doctor blades (300 and 600 μm gap height) were filled with the mixtures corresponding to the formulations based on capped or uncapped isocyanates and porous polyurethane layers were drawn on release paper by means of the film drawing apparatus at a rate of advance of 30 mm/s. The layers were dried at 180° C. for 5 minutes. After cooling, the layers were mechanically removed from the release paper.

Analysis of the Porous Polyurethane Layers

TABLE 4
Macroscopic evaluation of the polyurethane
layers based on capped isocyanates

| | | | Cell | | Σ Squares of |
|---|---|---|---|---|---|
| | Formu- | Flow | homo- | Homogeneity | the macr. |
| SC | lation | properties | geneity | over the area | evaluation |
| 1 | 1 | 5 | 4 | 4 | 57 |
| 2 | 1 | 5 | 4 | 4 | 57 |
| 3 | 1 | 5 | 4 | 4 | 57 |
| 4 | 1 | 5 | 4 | 4 | 57 |
| 5 | 1 | 5 | 3 | 4 | 50 |
| 6 | 1 | 5 | 3 | 4 | 50 |
| 7 | 1 | 5 | 3 | 3 | 43 |
| 8 | 1 | 2 | 4 | 4 | 36 |
| Comp. | 1 | 4 | 2 | 3 | 29 |
| 1 | | | | | |
| Comp. | 1 | 1 | 2 | 2 | 9 |
| 2 | | | | | |
| Comp. | 1 | 1 | 2 | 2 | 9 |
| 3 | | | | | |
| Comp. | 1 | 4 | 2 | 3 | 29 |
| 4 | | | | | |
| Comp. | 1 | 1 | 3 | 2 | 14 |
| 5 | | | | | |
| 9 | 1 | 5 | 3 | 4 | 50 |
| 10 | 1 | 5 | 4 | 3 | 50 |
| 11 | 1 | 5 | 4 | 3 | 50 |
| 12 | 1 | 4 | 3 | 4 | 41 |
| 13 | 1 | 4 | 3 | 5 | 50 |
| 14 | 1 | 4 | 3 | 4 | 41 |
| 15 | 1 | 4 | 5 | 2 | 45 |
| 16 | 1 | 4 | 4 | 4 | 48 |
| 17 | 1 | 5 | 4 | 2 | 45 |
| 18 | 1 | 4 | 3 | 4 | 41 |
| 19 | 1 | 5 | 4 | 3 | 50 |
| 20 | 1 | 4 | 3 | 4 | 41 |
| 21 | 1 | 5 | 3 | 5 | 59 |
| 22 | 1 | 4 | 4 | 3 | 41 |
| 23 | 1 | 5 | 5 | 3 | 59 |
| 24 | 1 | 5 | 4 | 2 | 45 |
| 25 | 1 | 5 | 4 | 4 | 57 |
| 26 | 1 | 4 | 3 | 4 | 41 |
| 27 | 1 | 4 | 4 | 3 | 41 |
| 28 | 1 | 5 | 4 | 4 | 57 |

TABLE 5
Macroscopic evaluation of the polyurethane
layers based on uncapped isocyanates

| | | | Cell | | Σ Squares of |
|---|---|---|---|---|---|
| | Formu- | Flow | homo- | Homogeneity | the macr. |
| SC | lation | properties | geneity | over the area | evaluation |
| 1 | 2 | 5 | 4 | 3 | 50 |
| 1 | 3 | 5 | 4 | 5 | 66 |
| 1 | 4 | 5 | 5 | 4 | 66 |
| 1 | 5 | 4 | 5 | 4 | 57 |
| 7 | 2 | 5 | 3 | 3 | 43 |
| 7 | 3 | 5 | 3 | 4 | 50 |
| 7 | 4 | 5 | 4 | 2 | 45 |
| 7 | 5 | 5 | 2 | 3 | 38 |
| 2 | 2 | 4 | 4 | 5 | 57 |
| 2 | 3 | 5 | 3 | 3 | 43 |
| 2 | 4 | 5 | 3 | 5 | 59 |
| 2 | 5 | 5 | 4 | 3 | 50 |
| Comp. 1 | 2 | 3 | 3 | 2 | 22 |
| Comp. 1 | 3 | 4 | 2 | 2 | 24 |
| Comp. 1 | 4 | 3 | 2 | 3 | 22 |
| Comp. 1 | 5 | 2 | 3 | 4 | 29 |
| Comp. 5 | 2 | 2 | 3 | 4 | 29 |
| Comp. 5 | 3 | 1 | 3 | 3 | 19 |
| Comp. 5 | 4 | 1 | 2 | 3 | 14 |
| Comp. 5 | 5 | 1 | 2 | 4 | 21 |
| 23 | 2 | 5 | 3 | 3 | 43 |
| 23 | 3 | 5 | 3 | 4 | 50 |
| 23 | 4 | 5 | 4 | 2 | 45 |
| 23 | 5 | 5 | 2 | 3 | 38 |
| 26 | 2 | 4 | 4 | 3 | 41 |
| 26 | 3 | 4 | 4 | 4 | 48 |
| 26 | 4 | 5 | 4 | 3 | 50 |
| 26 | 5 | 5 | 3 | 3 | 43 |

TABLE 6
Microscopic evaluation of the polyurethane
layers based on capped isocyanates

| | | | | | Σ Squares of |
|---|---|---|---|---|---|
| | Form- | | Cell | Proportion | the micr. |
| SC | ulation | Cell size | homogeneity | of open cells | evaluation |
| 1 | 1 | 2 | 3 | 3 | 22 |
| 2 | 1 | 4 | 3 | 1 | 26 |
| 3 | 1 | 4 | 2 | 2 | 24 |
| 4 | 1 | 4 | 3 | 3 | 34 |
| 5 | 1 | 4 | 4 | 3 | 41 |
| 6 | 1 | 2 | 2 | 3 | 17 |
| 7 | 1 | 2 | 2 | 3 | 17 |
| 8 | 1 | 2 | 3 | 3 | 22 |
| Comp. 1 | 1 | 2 | 1 | 2 | 9 |
| Comp. 2 | 1 | 2 | 2 | 1 | 9 |
| Comp. 3 | 1 | 2 | 2 | 2 | 12 |
| Comp. 4 | 1 | 2 | 1 | 1 | 6 |
| Comp. 5 | 1 | 1 | 2 | 1 | 6 |
| 9 | 1 | 3 | 3 | 3 | 27 |
| 10 | 1 | 3 | 2 | 4 | 29 |
| 11 | 1 | 4 | 4 | 3 | 41 |
| 12 | 1 | 2 | 4 | 2 | 24 |
| 13 | 1 | 4 | 4 | 2 | 36 |
| 14 | 1 | 3 | 3 | 4 | 34 |
| 15 | 1 | 3 | 2 | 4 | 29 |
| 16 | 1 | 4 | 3 | 3 | 34 |
| 17 | 1 | 4 | 3 | 2 | 29 |
| 18 | 1 | 4 | 4 | 3 | 41 |
| 19 | 1 | 5 | 2 | 2 | 33 |
| 20 | 1 | 3 | 3 | 4 | 34 |
| 21 | 1 | 3 | 4 | 1 | 26 |
| 22 | 1 | 4 | 4 | 3 | 41 |
| 23 | 1 | 4 | 2 | 2 | 24 |
| 24 | 1 | 2 | 3 | 4 | 29 |
| 25 | 1 | 4 | 3 | 4 | 41 |
| 26 | 1 | 3 | 2 | 4 | 29 |
| 27 | 1 | 3 | 2 | 5 | 38 |
| 28 | 1 | 4 | 3 | 3 | 34 |

TABLE 7
Microscopic evaluation of the polyurethane
layers based on uncapped isocyanates

| | | | | Proportion | Σ Squares of |
|---|---|---|---|---|---|
| | | Cell | Cell | of open | the macr. |
| SC | Formulation | size | homogeneity | cells | evaluation |
| 1 | 2 | 5 | 5 | 4 | 66 |
| 1 | 3 | 5 | 4 | 4 | 57 |
| 1 | 4 | 5 | 4 | 3 | 50 |
| 1 | 5 | 4 | 5 | 4 | 57 |
| 7 | 2 | 4 | 4 | 5 | 57 |
| 7 | 3 | 4 | 5 | 3 | 50 |
| 7 | 4 | 5 | 4 | 5 | 66 |
| 7 | 5 | 5 | 4 | 3 | 50 |
| 2 | 2 | 3 | 4 | 4 | 41 |
| 2 | 3 | 4 | 3 | 3 | 34 |
| 2 | 4 | 4 | 4 | 5 | 57 |
| 2 | 5 | 5 | 4 | 3 | 50 |
| Comp. 1 | 2 | 3 | 2 | 2 | 17 |
| Comp. 1 | 3 | 2 | 2 | 4 | 24 |
| Comp. 1 | 4 | 2 | 1 | 3 | 14 |
| Comp. 1 | 5 | 3 | 2 | 3 | 22 |
| Comp. 5 | 2 | 2 | 2 | 1 | 9 |
| Comp. 5 | 3 | 2 | 3 | 1 | 14 |
| Comp. 5 | 4 | 1 | 2 | 2 | 9 |
| Comp. 5 | 5 | 1 | 2 | 3 | 14 |
| 23 | 2 | 5 | 5 | 4 | 66 |
| 23 | 3 | 5 | 4 | 4 | 57 |
| 23 | 4 | 5 | 4 | 3 | 50 |
| 23 | 5 | 4 | 5 | 4 | 57 |
| 26 | 2 | 4 | 4 | 5 | 57 |
| 26 | 3 | 4 | 5 | 3 | 50 |
| 26 | 4 | 5 | 4 | 5 | 66 |
| 26 | 5 | 5 | 4 | 3 | 50 |

TABLE 8
Basic macroscopic data for the polyurethane layers
based on capped isocyanates

| | | | | Proportion |
|---|---|---|---|---|
| | | Weight per unit | Density | of cells |
| SCC | Formulation | area in g/m² | in kg/m³ | in % |
| 1 | 1 | 319 | 581 | 47 |
| 2 | 1 | 339 | 731 | 34 |
| 3 | 1 | 463 | 681 | 38 |
| 4 | 1 | 353 | 579 | 47 |
| 5 | 1 | 313 | 668 | 39 |
| 6 | 1 | 394 | 673 | 39 |
| 7 | 1 | 360 | 563 | 49 |
| 8 | 1 | 344 | 586 | 47 |
| 9 | 1 | 498 | 830 | 25 |
| 10 | 1 | 364 | 579 | 47 |
| 11 | 1 | 464 | 622 | 43 |
| 12 | 1 | 332 | 738 | 33 |
| 13 | 1 | 244 | 678 | 38 |
| 14 | 1 | 219 | 730 | 34 |
| 15 | 1 | 286 | 656 | 40 |
| 16 | 1 | 394 | 673 | 39 |
| 17 | 1 | 323 | 662 | 40 |
| 18 | 1 | 339 | 581 | 45 |
| 19 | 1 | 410 | 594 | 46 |
| 20 | 1 | 456 | 662 | 40 |
| 21 | 1 | 490 | 754 | 31 |
| 22 | 1 | 363 | 558 | 49 |
| 23 | 1 | 273 | 635 | 42 |
| 24 | 1 | 278 | 621 | 44 |
| 25 | 1 | 463 | 747 | 32 |
| 26 | 1 | 368 | 679 | 38 |
| 27 | 1 | 323 | 584 | 47 |
| 28 | 1 | 308 | 657 | 40 |
| Comp. 1 | 1 | 503 | 967 | 12 |
| Comp. 2 | 1 | 251 | 900 | 18 |
| Comp. 3 | 1 | 179 | 861 | 22 |
| Comp. 4 | 1 | 324 | 774 | 30 |
| Comp. 5 | 1 | 504 | 919 | 16 |

TABLE 9
Basic macroscopic data for the polyurethane layers
based on uncapped isocyanates

| | | | | Proportion of |
|---|---|---|---|---|
| | | Weight per unit | Density | cells |
| SC | Formulation | area in g/m² | in kg/m³ | in % |
| 1 | 2 | 260 | 650 | 41 |
| 1 | 3 | 285 | 671 | 39 |
| 1 | 4 | 310 | 561 | 49 |
| 1 | 5 | 305 | 649 | 41 |
| 7 | 2 | 320 | 734 | 33 |
| 7 | 3 | 275 | 663 | 40 |
| 7 | 4 | 336 | 737 | 33 |
| 7 | 5 | 410 | 661 | 40 |
| 2 | 2 | 342 | 697 | 37 |
| 2 | 3 | 298 | 683 | 38 |
| 2 | 4 | 313 | 683 | 38 |
| 2 | 5 | 346 | 676 | 39 |
| Comp. 1 | 2 | 251 | 804 | 27 |
| Comp. 1 | 3 | 263 | 824 | 25 |
| Comp. 1 | 4 | 247 | 855 | 22 |
| Comp. 1 | 5 | 256 | 921 | 16 |
| None | 2 | 186 | 899 | 18 |
| None | 3 | 203 | 923 | 16 |
| None | 4 | 186 | 877 | 20 |
| None | 5 | 181 | 862 | 22 |
| 23 | 2 | 321 | 682 | 38 |
| 23 | 3 | 316 | 652 | 41 |
| 23 | 4 | 331 | 643 | 42 |
| 23 | 5 | 309 | 636 | 42 |
| 26 | 2 | 362 | 662 | 40 |
| 26 | 3 | 379 | 661 | 40 |
| 26 | 4 | 354 | 636 | 42 |
| 26 | 5 | 321 | 682 | 38 |

TABLE 10
Mechanical properties of the polyurethane
layers based on capped isocyanates

| | | | | Elongation at |
|---|---|---|---|---|
| | | Stress at 100% | Breaking stress | break |
| SC | Formulation | elongation in MPa | in MPa | in % |
| 1 | 1 | 1.34 | 1.69 | 142 |
| 6 | 1 | 0.88 | 1.38 | 180 |
| Comp. 5 | 1 | 0.99 | 1.03 | 97 |

The results of the comparative examples are, both in the case of the macroscopic and microscopic evaluations and also in the case of the mechanical properties, very significantly below the values obtained with the additives according to the invention. This also applies to the proportions of cells.

1. A porous polyurethane layer comprising at least one silicon-containing compound, wherein the silicon-containing compound has the formula (1) 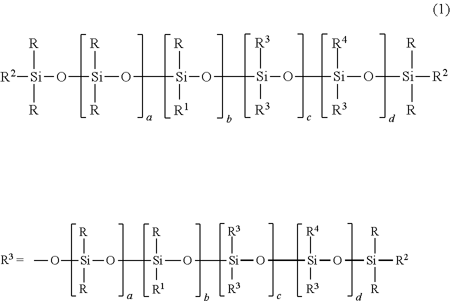
where
a is independently from 0 to 500,
b is independently from 0 to 60,
c is independently from 0 to 10,
d is independently from 0 to 10,
with the proviso that, for each molecule of the formula (1), the average number Σd of T units and the average number Σc of Q units per molecule is not greater than 50 in either case, the average number Σa of D units per molecule is not greater than 2000 and the average number Σb of the siloxy units bearing R¹ per molecule is not greater than 100,
R is independently at least one radical from the group of linear, cyclic or branched, aliphatic or aromatic, saturated or unsaturated hydrocarbon radicals having from 1 up to 20 carbon atoms,
R² is independently R¹ or R,
R¹ is different from R and R¹ is a radical selected from the group consisting of 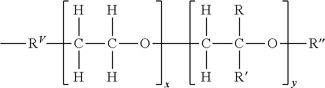
—CH₂—CH₂—CH₂—O—(CH₂—CH₂O)ₓ—(CH₂—CH(R′)O—)_{y}—R″
—CH₂—CH₂—O—(CH₂—CH₂O)ₓ—(CH₂—CH(R′)O—)_{y}—R″
—O—(C₂H₄O—)ₓ—(C₃H₅O—)_{y}—R′
—CH₂—R^{IV}
—CH₂—CH₂—(O)_{x′}—R^{IV}
—CH₂—CH₂—CH₂—O—CH₂—CH(OH)—CH₂OH 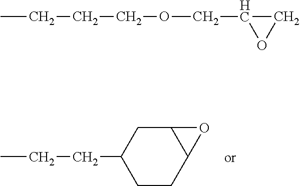
—CH₂—CH₂—CH₂—O—CH₂—C(CH₂OH)₂—CH₂—CH₃,
where
x is from 0 to 100,
x′ is 0 or 1,
y is from 0 to 100,
R′ is independently an optionally substituted alkyl or aryl group having from 1 to 12 carbon atoms, substituted, for example, by alkyl radicals, aryl radicals or haloalkyl or haloaryl radicals, where different R′ is independently an substituted alkyl or aryl group having from 1 to 12 carbon atoms, substituted, for example, by alkyl radicals, aryl radicals or haloalkyl or haloaryl radicals, where different R′ substituents may be present within any R¹ radical and/or any molecule of the formula (1), and
R″ is independently a hydrogen radical or an alkyl group having from 1 to 4 carbon atoms, a C(O)—R′″ group with R″′=alkyl radical, a —CH₂—O—R′ group, an alkylaryl group, for example a benzyl group, or a —C(O)NH—R′ group,
R^{IV} is a linear, cyclic or branched, optionally substituted, e.g. substituted by halogens, hydrocarbon radical having from 1 to 50, carbon atoms,
R^{V} —D—G_{z}—
where D is a linear, cyclic or branched, optionally substituted, e.g. substituted by heteroatoms such as O, N or halogens, saturated or unsaturated hydrocarbon radical having from 2 to 50, carbon atoms,
G corresponds to one of the following formulae 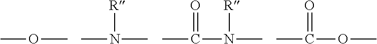
z can be 0 or 1,
where R¹ can also be bridging in the sense that two or three siloxane structures of the formula (1) can be joined via R¹, in which case R″ or R^{IV} are correspondingly bifunctional groups, i.e. R^{V},
R⁴ may independently be R, R¹ and/or a functionalized, organic, saturated or unsaturated radical having substitution by heteroatoms, selected from the group of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl and vinyl radical,
with the proviso that at least one substituent from R¹, R² and R⁴ is not R.

2. The porous polyurethane layer according to claim 1, wherein the thickness of the polyurethane layer is in the range from 0.05 to 5 mm.

3. The porous polyurethane layer according to claim 1, wherein the total amount of the silicon-containing compound(s) of the formula (1) used is, based on the finished polyurethane, from 0.01 to 10% by weight.

4. The porous polyurethane layer according to claim 1, wherein a solvent-free or low-solvent process is used for producing the porous polyurethane layer.

5. The porous polyurethane layer according to claim 1, wherein chemically blocked, NCO prepolymers and crosslinkers, comprising aliphatic and/or cycloaliphatic and/or aromatic amines having at least two primary and/or secondary amino groups are used for producing the porous polyurethane layer.

6. The porous polyurethane layer according to claim 1, wherein a polyol component, a catalyst and a polyisocyanate and/or a polyisocyanate prepolymer are used for producing the porous polyurethane layer.

7. The porous polyurethane layer according to claim 1 wherein the silicon-containing compound has the formula (1) wherein
a is from 2 to 150,
b is from 1 to 30,
c is from 0 to 5,
d is from 0 to 5, and
R is a methyl radical.

8. A process for producing a composite structure comprising at least one porous polyurethane layer and a support layer, where the at least one porous polyurethane layer is applied directly or indirectly to a support layer and the at least one polyurethane layer is formed by applying a reactive composition capable of forming a polyurethane to the support layer and curing the reactive composition, wherein the formation of the porous polyurethane layer is carried out in the presence of a silicon-containing compound of the formula (1) 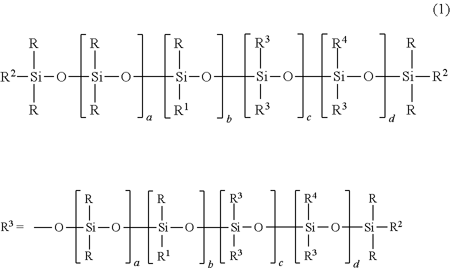
where
a is independently from 0 to 500,
b is independently from 0 to 60,
c is independently from 0 to 10,
d is independently from 0 to 10,
with the proviso that, for each molecule of the formula (1), the average number Σd of T units and the average number Σc of Q units per molecule is not greater than 50 in either case, the average number Σa of D units per molecule is not greater than 2000 and the average number Σb of the siloxy units bearing R¹ per molecule is not greater than 100,
R is independently at least one radical from the group of linear, cyclic or branched, aliphatic or aromatic, saturated or unsaturated hydrocarbon radicals having from 1 up to 20 carbon atoms.
R² is independently R¹ or R,
R¹ is different from R and is independently an organic radial and/or a polyether radical,
R¹ is a radical selected from the group consisting of 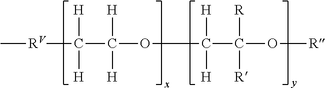
—CH₂—CH₂—CH₂—O—(CH₂—CH₂O—)ₓ—(CH₂—CH(R′)O—)_{y}—R″
—CH₂—CH₂—O—(CH₂—CH₂O—)ₓ—(CH₂—CH(R′)O—)_{y}—R″
—O—(C₂H₄O—)ₓ—(C₃H₅O—)_{y}—R′
—CH₂—R^{IV}
—CH₂—CH₂—(O)_{x′}—R^{IV}
—CH₂—CH₂—CH₂—O—CH₂—CH(OH)—CH₂OH 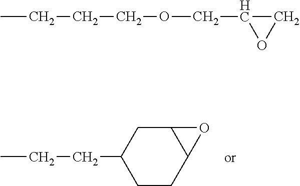
—CH₂—CH₂—CH₂—O—CH₂—C(CH₂OH)₂—CH₂—CH₃,
where
x is from 0 to 100,
x′ is 0 or 1,
y is from 0 to 100,
R′ is independently an optionally substituted alkyl or aryl group having from 1 to 12 carbon atoms, substituted, for example, by alkyl radicals, aryl radicals or haloalkyl or haloaryl radicals, where different R′ is independently an optionally substituted alkyl or aryl group having from 1 to 12 carbon atoms, substituted, for example, by alkyl radicals, aryl radicals or haloalkyl or haloaryl radicals, where different R′ substituents may be present within any R¹ radical and/or any molecule of the formula (1), and
R″ is independently a hydrogen radical or an alkyl group having from 1 to 4 carbon atoms, a C(O)—R′″ group with R″′=alkyl radical, a —CH₂—O—R′ group, an alkylaryl group, for example a benzyl group, or a —C(O)NH—R′ group,
R^{IV} is a linear, cyclic or branched, optionally substituted, e.g. substituted by halogens, hydrocarbon radical having from 1 to 50 carbon atoms,
R^{V} —D—G_{z}—
where D is a linear, cyclic or branched, optionally substituted, e.g. substituted by heteroatoms such as O, N or halogens, saturated or unsaturated hydrocarbon radical having from 2 to 50 carbon atoms,
G corresponds to one of the following formulae 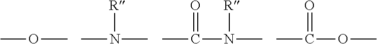
z can be 0 or 1,
where R¹ can also be bridging in the sense that two or three siloxane structures of the formula (1) can be joined via R¹, in which case R″ or R^{IV} are correspondingly bifunctional groups, i.e. R^{V},
R⁴ may independently be R, R¹ and/or a functionalized, organic, saturated or unsaturated radical having substitution by heteroatoms, selected from the group of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl and vinyl radical,
with the proviso that at least one substituent from R¹, R² and R⁴ is not R.

9. The process for producing a composite structure according to claim 8, wherein the reactive composition capable of forming a polyurethane comprises chemically blocked, NCO prepolymers and crosslinkers, comprising aliphatic and/or cycloaliphatic and/or aromatic amines having at least two primary and/or secondary amino groups.

10. The process for producing a composite structure according to claim 8, wherein the reactive composition capable of forming a polyurethane comprises
i) a polyol having primary and/or secondary terminal hydroxy functions,
ii) a polyisocyanate and/or a polyisocyanate prepolymer, and
iii) a catalyst.

11. The composite structure comprising at least one porous polyurethane layer according to claim 7 and a support layer, wherein the two layers are joined indirectly or directly to one another.

12. The composite structure obtainable by the process according to claim 8.

13. An artificial leather comprising the composite structure according to claim 11.

14. A foam film comprising the composite structure according to claim 11.

15. The porous polyurethane layer according to claim 1, wherein the thickness of the polyurethane layer is in the range from 0.15 to 1 mm.

16. The porous polyurethane layer according to claim 1, wherein the total amount of the silicon-containing compound(s) of the formula (1) used is, based on the finished polyurethane, from 0.1 to 3% by weight.

17. The porous polyurethane layer according to claim 1, wherein chemically blocked, NCO prepolymers and crosslinkers, comprise aliphatic and/or cycloaliphatic and/or aromatic amines having at least two primary and/or secondary amino groups are used for producing the porous polyurethane layer.

18. The process for producing a composite structure according to claim 8, wherein the reactive composition capable of forming a polyurethane comprises oxime-blocked, NCO prepolymers and crosslinkers, comprising aliphatic and/or cycloaliphatic and/or aromatic amines having at least two primary and/or secondary amino groups.

19. The porous polyurethane layer according to claim 1 wherein the silicon-containing compound has the formula (1) wherein
R¹ is different from R and is independently an organic radial and/or a polyether radical,
R¹ is a radical selected from the group consisting of 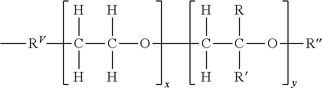
—CH₂—CH₂—CH₂—O—(CH₂—CH₂O—)ₓ—(CH₂—CH(R′)O—)_{y}—R″
—CH₂—CH₂—O—(CH₂—CH₂O—)ₓ—(CH₂—CH(R′)O—)_{y}—R″
—O—(C₂H₄O—)ₓ—(C₃H₅O—)_{y}—R′
—CH₂—R^{IV}
—CH₂—CH₂—(O)_{x′}—R^{IV}
—CH₂—CH₂—CH₂—O—CH₂—CH(OH)—CH₂OH 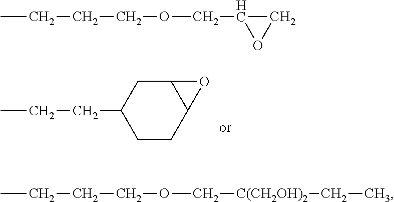
where
x is from 1 to 50,
x′ is 0 or 1,
y is from 1 to 50,
R′ is independently an optionally substituted alkyl or aryl group having from 1 to 12 carbon atoms, substituted, for example, by alkyl radicals, aryl radicals or haloalkyl or haloaryl radicals, where different R′ is independently an optionally substituted alkyl or aryl group having from 1 to 12 carbon atoms, substituted, for example, by alkyl radicals, aryl radicals or haloalkyl or haloaryl radicals, where different R′ substituents may be present within any R¹ radical and/or any molecule of the formula (1), and
R″ is independently a hydrogen radical or an alkyl group having from 1 to 4 carbon atoms, a C(O)—R′″ group with R″′=alkyl radical, a —CH₂—O—R′ group, an alkylaryl group, for example a benzyl group, or a —C(O)NH—R′ group,
R^{IV} is a linear, cyclic or branched, optionally substituted, e.g. substituted by halogens, hydrocarbon radical having from 13 to 37 carbon atoms,
R^{V} —D—G_{z}—
where D is a linear, cyclic or branched, optionally substituted, e.g. substituted by heteroatoms such as O, N or halogens, saturated or unsaturated hydrocarbon radical having from 4 to 37, carbon atoms,
G corresponds to one of the following formulae 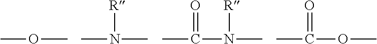
z can be 0 or 1,
where R¹ can also be bridging in the sense that two or three siloxane structures of the formula (1) can be joined via R¹, in which case R″ or R^{IV} are correspondingly bifunctional groups, i.e. R^{V},
R⁴ may independently be R, R¹ and/or a functionalized, organic, saturated or unsaturated radical having substitution by heteroatoms, selected from the group of the alkyl, aryl, chloroalkyl, chloroaryl, fluoroalkyl, cyanoalkyl, acryloyloxyaryl, acryloyloxyalkyl, methacryloyloxyalkyl, methacryloyloxypropyl and vinyl radical,
with the proviso that at least one substituent from R¹, R² and R⁴ is not R.

20. The porous polyurethane layer according to claim 2 wherein the silicon-containing compound has the formula (1).
